(19) United States
(12) Patent Application Publication
(10) Pub. No.: US 2025/0355724 A1
(43) Pub. Date: Nov. 20, 2025

(54) REAL-TIME COMPUTATIONAL KERNEL

(71) Applicant: Twilio Inc., San Francisco, CA (US)

(72) Inventors: Andrius Vaskys, San Francisco, CA (US); Jacob Bogerd, Durham, NC (US); Joris Basiglio, Washington, DC (US); Gurkanwal Singh Batra, San Francisco, CA (US); Thomas Schnabel, Durham, NC (US)

(21) Appl. No.: 18/667,755

(22) Filed: May 17, 2024

(51) Int. Cl. G06F 9/50; G06F 16/2455

(52) U.S. Cl. CPC G06F 9/5083; G06F 16/24568

(57) ABSTRACT

Methods and systems for using a cloud-managed state store are disclosed. A stream of data is received via a network. State information for a real-time computation workload is stored in a cloud-managed state store. The real-time computation workload is scaled out by utilizing the cloud-managed state store to retrieve state information. The stream of data is processed using a processing engine and utilizing the retrieved state information from the cloud-managed state store. Results of processing the stream of data are stored in the cloud-managed state store.

### TECHNICAL FIELD

The disclosed subject matter relates generally to the technical fields of cloud computing, distributed processing, and real-time data stream processing and, in one specific embodiment, to methods and systems for elastic real-time computation of data streams using a cloud-managed state store.

### BACKGROUND

The ability to perform real-time computation and analysis on unbounded data streams has become increasingly critical across various industries and applications. For instance, fraud detection, personalized recommendations, predictive maintenance, and other use cases rely on processing continuous streams of data to extract timely insights and trigger actions.

### BRIEF DESCRIPTION OF THE DRAWINGS

Some embodiments are illustrated by way of example and not limitation in the figures of the accompanying drawings.

FIG. 1 is a network diagram depicting a cloud-based SaaS system within which various example embodiments may be deployed.

FIG. 2 is a block diagram illustrating example modules of the service(s) of FIG. 1.

FIG. 3 is a block diagram depicting consumption from a profile patch stream.

FIG. 4 is a block diagram depicting a detailed view of the worker's operation.

FIG. 5 is a flow chart of example operations for performing elastic real-time computations.

FIG. 6 is a block diagram depicting processing of an example computation expression.

FIG. 7 is a block diagram illustrating an example elastic state store for cloud state store (e.g., DynamoDB).

FIG. 8 is a block diagram of an example mobile device, according to an example embodiment.

FIG. 9 is a block diagram of machine in the example form of a computer system within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

A key challenge with such solutions is that they tightly couple state storage and stream processing within the engine itself. The engine handles partitioning state across nodes in the cluster, checkpointing it to durable storage, and routing data to relevant state during processing. This provides efficiency through data locality but lacks flexibility and elasticity.

Various proprietary cloud services have also emerged to handle real-time stream computation workloads, including AWS Kinesis Data Analytics, Google Cloud Dataflow, Azure Stream Analytics, and Confluent Cloud. These services aim to simplify authoring stream processing logic but still rely on fixed clusters and state management schemes.

Existing real-time computation solutions lack flexible and elastic state management capabilities to efficiently handle spikes and variations in stream processing workloads.

The disclosed system, which may be referred to as an “elastic real-time compute kernel” system, is designed to address various problems of using distributed dataflow engines like Apache Flink for real-time stream processing workloads. In example embodiments, an external cloud-managed state store replaces the state management functionality typically bundled into the dataflow engines.

In a coupled storage and compute model, it is difficult to efficiently scale out computation for load spikes without an expensive redistribution of state partitions. Such systems may also suffer from operational challenges due to a lack of zero-downtime elasticity.

In contrast, in example embodiments, the disclosed system leverages a fully-managed cloud state store, such as DynamoDB, instead of built-in state management of a distributed dataflow engine. This cloud-managed state store allows much easier scaling out of computation since new resources can directly access the remotely stored state. The system no longer needs to redistribute state partitions each time additional capacity is needed.

The use of the external state store helps optimize the workload in other ways as well. Storing all user state in a single database record avoids duplication across operators. And the system can aggressively optimize the size of the state by using integer user IDs and pruning fields that are no longer needed after certain conditions are met.

Additionally, in example embodiments, the system is integrated with an upstream Profile Patch Stream to subscribe to changes for user records. This allows further state size optimizations because the latest trait values are directly available; no local aggregation is needed. The patch stream also enables “signaling events” allowing out-of-band changes to be ordered alongside regular profile updates.

On the computation side, the system introduces “compiled computation,” which includes decomposing each real-time computation into constituent parts that can be evaluated independently. This compiled computation allows more efficient re-computation and can be configured such that only certain event aggregations may need to be re-executed in response to a change.

In example embodiments, the system uses special techniques for storing state related to event-based aggregations. For example, rather than maintaining a separate aggregated value for each event-based condition, the system employs a novel storage format that reduces duplication.

In example embodiments, each user's state is stored as a single key-value record mapping various “evaluated nodes” to their state. These evaluated nodes correspond to each unique instance of an event aggregation referenced across the user's computations. These techniques allow the system to avoid having to separately aggregate and maintain the same event counts in multiple places.

Within this storage structure, additional optimizations are enabled based on the type of aggregation node:

Terminal nodes-Once an aggregation reaches a threshold where its Boolean output will never change, that state is stored directly as a terminal value to avoid unnecessary re-computations.

Performed all-time conditions—These single-event thresholds can be stored as a simple Boolean rather than maintaining an integer counter.

General count thresholds—The minimum state needed to assess the threshold condition is stored, avoiding continuously incrementing counts when no longer needed.

Together, these techniques allow the system to significantly reduce the amount of per-user state that needs to be maintained related to event aggregations and associated computations. This is what enables cost-effective scaling out while relying primarily on a cloud-based state store within the architecture.

The system architecture is designed to leverage these innovations for increased efficiency, elasticity, and developer velocity compared to a traditional Flink-based deployment. The ability to scale out via the cloud-based state store enables better handling of load spikes and throughput bursts. And offloading state management relieves a significant operational burden as well.

Methods and systems for using a cloud-managed state store are disclosed. A stream of data is received via a network. State information for a real-time computation workload is stored in a cloud-managed state store (e.g., that is separate from a processing engine used to process the stream of data). The real-time computation workload is scaled out by utilizing the cloud-managed state store to retrieve state information. The stream of data is processed using the processing engine and utilizing the retrieved state information from the cloud-managed state store. Results of processing the stream of data are stored in the cloud-managed state store.

Methods and systems for scaling out real-time computations are disclosed. A stream of event data associated with a plurality of users is received. A set of event-based aggregations to be computed for the plurality of users is determined based on the received stream of event data. User information for the plurality of users is stored in a state store (e.g., that is separate from a processing engine used to process the stream of data). Computation of the determined set of event-based aggregations is dynamically scaled out using the stored user information. The set of event-based aggregations is computed for the plurality of users from the received stream of event data using the dynamically scaled out computation. The computed event-based aggregations for the plurality of users are stored in the state store.

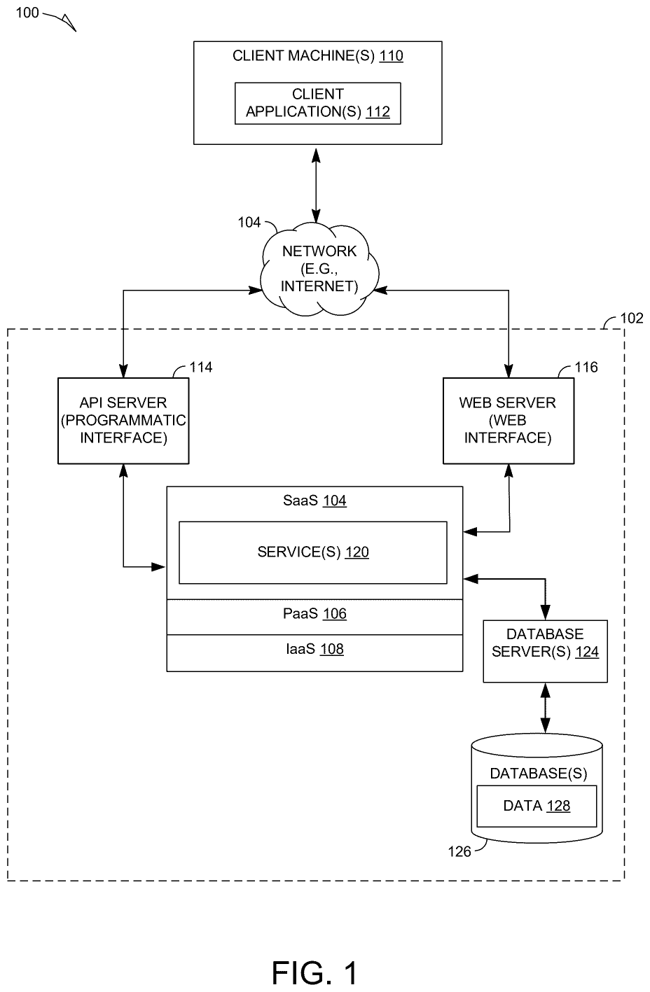

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The figure illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 112 may include a software application module (e.g., a plug-in, add-in, or macro) that adds a specific service or feature to the application.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., service(s)) 120 are shown in the figure to form part of the networked system 102, in alternative embodiments, the applications 120 may form part of a service that is separate and distinct from the networked system 102.

Further, while the system 100 shown in the figure employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although the figure depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may accesses the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server application(s) and/or service(s) 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as the system's data items 128. In example embodiments, the system's data items may be any of the data items described herein.

Navigation of the networked system 102 may be facilitated by one or more navigation applications. For example, a search application (as an example of a navigation application) may enable keyword searches of data items included in the one or more database(s) 126 associated with the networked system 102. A client application may allow users to access the system's data 128 (e.g., via one or more client applications). Various other navigation applications may be provided to supplement the search and browsing applications.

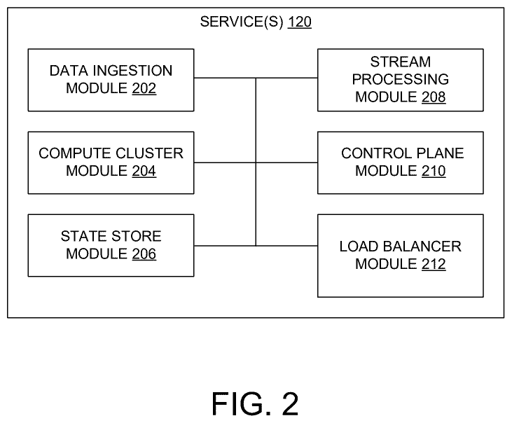

FIG. 2 is a block diagram illustrating example modules 200 of the service(s) 120 of FIG. 1. Data Ingestion Module 202 is configured to be responsible for receiving and preprocessing incoming data streams before they are processed. The Data Ingestion Module 202 may perform one or more of the following operations on incoming data streams:

Data validation—This involves validating the structure, formats, and values in the incoming data to ensure they meet expected specifications. For example, the module may validate that a user ID field contains properly formatted identifiers, an event timestamp is a valid date, event property values are of the correct data types, etc. Strong data validation prevents bad data from entering the system and causing errors.

Data normalization—The raw incoming data may be transformed into normalized forms to simplify processing downstream. For instance, currency values may be converted into a standard currency, product IDs may be mapped to a canonical list, event names may be normalized to a controlled vocabulary, etc.

Data enrichment—Additional data from external sources may be added to the raw input to make it more useful for real-time computation. For example, geo-location data may be appended based on IP addresses, product metadata may be pulled into product events, etc.

Data filtering—The incoming streams may be filtered to remove unused or irrelevant events to optimize the data processed through the real-time computation workload. This filtering may be based on event types, property values, frequency thresholds, or other criteria.

Data compression—Input stream data may be compressed to reduce the volume of data that must be processed and stored. Common compression schemes like GZIP or Snappy can dramatically shrink the size of many real-time event streams.

Data partitioning—The preprocessed input stream may be partitioned into shards to enable parallel distributed processing. Partitioning may be based on event types, user IDs, or other factors to ensure related data ends up in the same shards.

Result materialization—Some partial results may be precomputed during ingestion to accelerate real-time computation. For example, common aggregations like event counts may be updated in real-time rather than recomputed each time.

The data ingestion architecture and preprocessing may help ensure that the system achieves high performance, accuracy, and cost efficiency when operating at large scale across thousands of events per second. The data may be validated, transformed, enriched, filtered, compressed, partitioned, and staged to enable fast follow-on processing.

A Compute Cluster Module 204 is configured to manages the allocated compute resources used to execute the real-time processing logic. It can scale out to add resources during spikes in load. It does not rely on distributed dataflow engine clusters.

A State Store Module 206 is configured to provide one or more interfaces to a cloud-managed state store (e.g., DynamoDB). It handles state lookups, updates, versioning, etc. It can replace state management functionality previously handled by engines like Apache Flink. While the examples herein may focus on Amazon DynamoDB, the elastic state store could be powered by any highly scalable, low latency cloud database. Some other potential implementations include, for example, Google BigTable, Azure CosmosDB, Apache Cassandra, ScyllaDB, Amazon Timestream, FaunaDB, or MongoDB. Requirements for the state store may include the ability to handle writes and reads of small state objects at very high throughput and low consistent latency while scaling elastically.

A Stream Processing Module 208 is configured to execute real-time computation logic on the incoming data streams utilizing state information. It does not rely on distributed dataflow engines like Apache Flink to process data.

A Control Plane Module 210 is configured to manages and/or orchestrate the overall data flows and operations. It can allocate resources, monitor for failures, redistribute state partitions, etc. without relying on distributed dataflow engines.

A Load Balancer Module 212 is configured to distributes incoming data across compute resources and balance workload. It can route data to least loaded resources without relying on distributed dataflow engine capabilities.

The Control Plane Module 210 and Load Balancer Module 212 shown may be responsible for managing and coordinating the real-time computation system. Their capabilities may include:

Computation deployment—The Control Plane determines what computation code needs to run across the Stream Processing Module workers and deploys packaged code bundles accordingly.

Stream balancing—The Load Balancer Module evenly distributes incoming event streams across Stream Processing workers to prevent hot spots.

Auto-scaling—The Control Plane automatically scales out the cluster by adding Stream Processing Module instances during spikes in load based on policies.

Failure handling—The Control Plane detects and responds to failures of processing nodes or state store partitions. It may redistribute state partitions to available nodes.

State rebalancing—To optimize performance, the Control Plane may rebalance the state partitions across Stream Processing workers to evenly distribute load.

Metrics collection—Key operational metrics are gathered from across the cluster to enable monitoring and inform control plane decisions.

Orchestration—Workflow orchestration capabilities help coordinate and sequence multi-step state migrations, code deployments, and topology changes.

Backfill management—The Control Plane manages the distribution of backfill update events to Stream Processing workers and the rate of backfill traffic.

The system provides robust orchestration and control capabilities for real-time computation at large scale and for mission-critical workloads. The control plane may be thought of as the “brains” of the distributed system, making intelligent decisions and automatically optimizing performance and reliability.

Even a system comprising a high-scale multi-tenant real-time compute aggregation engine, such as one powered by a framework and/or distributed processing engine for stateful computation over unbounded or bounded data streams (e.g., Apache Flink), which may power tens of thousands of real-time computed traits, audiences, or journeys, may be cumbersome to scale to a higher order of magnitude of customer load. For example, there may be a few properties of such a system that may cause pain. For example, the distributed processing engine may provide many stateful stream processing building blocks (e.g., keyed state, a scalable timer service, or event time watermarking). One of the architectural features of the engine may be that it provides data locality. The working copy of the stream processing state dataset may be split across a cluster of nodes and stored in-memory and/or on a locally-attached SSD (e.g., with periodic checkpointing to cloud storage for durability). This has the advantage of making individual state operations cheap and strongly consistent. Each unit of stream processing work is routed to the node managing the relevant keyspace, and then all state operations within that keyspace are performed locally and sequentially.

However, this locality also has drawbacks. Because each piece of state data is housed on a single node, failures (and/or redeployments) may require a costly, time-consuming re-download of the checkpointed state from cloud storage. And if the system temporarily needs additional processing power to handle a spike in load (e.g., on a Black Friday spike or even an individual customer creating a flurry of new computations), this requires an even more time-consuming state redistribution operation in order to spread the state out over a larger set of parallel tasks, which can a long time (e.g., hours) depending on the current state size. This means that such a system can't scale out under anything but the most dire of circumstances. This coupled compute and storage model limits the system's operational nimbleness, requires provisioning of extra capacity long ahead of time to handle anticipated load spikes and state size increases (e.g., this capacity goes to waste during periods of low demand), and forces building of a sophisticated load management system to smooth out the worst of the spikes.

Another problem may result from the topology of the stream processing job that is built on top of the distributed processing engine. Consider a simplified view of a compute-real-time streaming topology for a single computation.

In this architecture, each computation may be split into one or more aggregations, which are fanned out and processed independently, potentially on separate machines. An aggregation can include, for example, a value calculated over a series of events (e.g., an event counter) or a trait reference. The aggregations may be re-keyed to handle merges, and then re-keyed or shuffled (e.g., to be combined into a final per-user expression value).

This architecture may have many issues, such as, for example, one or more of the following issues:
A single inbound event can fan out into many units of work (e.g., an event referenced in multiple aggregations or an identify call with multiple trait updates);
It may be hard for the customer or user of the system to understand—and it may be hard for the system to explain—how much the compute workload will cost for the customer or user; The system is dependent on variables such as the customer's tracking plan and/or audience configuration, rather than a simpler variable, such as API call volume;
Backfilling a single audience member can cause a variable amount of work, depending on how many conditions that audience has, thus, it may be hard to maintain our first-time compute service level objectives;
It may be difficult to implement holistic optimizations; for example, if an audience condition is count (Page Viewed)>=1, there may b no need to recalculate the audience after additional page views;
Lack of transactionality;
One event can fan out into multiple aggregations in multiple computations, each of which gets processed independently;
One backfill message can cause multiple re-computations;
A single input event can cause multiple outputs (one for each computation). For example, in the JPMC case, an input load of 10k events/see can fan out into 60k updates/see;
The system may not be able to answer the question, “what message caused this user to enter the audience?”;
Duplicated state;
Because a aggregation gets shuffled and re-keyed multiple times throughout the pipeline, the system may have to copy many pieces of state over to the next downstream operator to ensure that data is present where it is needed; and/or
Lots of shuffling and redundant state lookup operations.

The system's product pain points may include, for example, one or more of the following:
Struggling e2e SLO;
Inability to react to load spikes;
Inefficiencies due to lack of transactionality (eg, a backfill with 10 traits causes 10 re-computations);
Fragmented spare capacity (cluster A can't help cluster B with its load problems);
Downtime during routine deployments;
Hard-to-explain costs;
Cluster costs move as a step-function;
Paying for unused capacity due to the need to have spare capacity for spikes;
A single ingest message can cause hugely variable amounts of system load;
Long lead-time to increase capacity;
Needed weeks of engineering time in order to say “yes” to JPMC;
Inability to temporarily scale out;
Real-time computations may need to be moved to a batch system during a big event, such as the World Cup, because the system may not be able to scale out; and/or
Low product velocity—the system may be extremely difficult to work on;
The system described herein (referred to as the service(s) or an elastic real-time compute kernel) solves the problems of the system described above. It features, for example, one or more of the following:
An elastic, cloud-managed state store (e.g., DynamoDB), which may replace a distributed-processing-engine-based inelastic store (e.g., RocksDB-on-NVMe implementation);
Worker processes (e.g., Go workers running in k8s), which may replace one or more components of a distributed-processing-engine-based deployment infrastructure;
Compatibility with various real-time compute control plane, orchestration (e.g., backfill or edit), or sync implementations; and/or
Load management via scale-out rather than load throttling/deprioritization.

The processing of various streams of data is contemplated, one exemplary form of which is user analytics data. User analytics data may refer to a collection of data points that are indicative of user interactions, behaviors, preferences, and/or activities across a digital platform or service. This data may be generated as users engage with applications, websites, or other digital interfaces, and can include, but is not limited to, event data, log data, transactional data, and user profile updates.

User analytics data may be characterized by its real-time or near-real-time generation, its unbounded nature, and its potential to be voluminous and high-velocity. This data is often heterogeneous, comprising structured, semi-structured, and/or unstructured data types. The data may include, for example, timestamps, user identifiers, event types, event properties, session information, and/or metadata.

The system may be configured to receive user analytics data as a continuous stream. The data ingestion module may be responsible for the initial collection and preprocessing of the incoming user analytics data stream. This module may ensure that the data conforms to expected formats and schemas, validate the integrity and/or authenticity of the data, and/or perform any necessary transformations to normalize the data for downstream processing.

Upon ingestion, the user analytics data may be processed by a processing engine, which may be configured to apply a set of user-specified rules to the data. These rules may be preloaded into the system and may define one or more criteria for grouping users. The rules may be based on various attributes, such as user demographics, behaviors, engagement levels, and/or other relevant metrics derived from the user analytics data.

The processing engine may utilize state information retrieved from a cloud-managed state store to efficiently group the user analytics data. This state store may be separate from the processing engine and may be configured to scale elastically with the volume of incoming data. The state store may maintain the current state of each user's data as it pertains to the user-specified rules, enabling the system to dynamically group users as new data is received.

In example embodiments, the system employs state pruning techniques to optimize the storage and management of state information, as described herein. State pruning may involve evaluating the user analytics data in the context of the entire expression defined by the user-specified rules. When the system determines that certain state information can no longer change the outcome of the grouping rules—such as when a threshold has been permanently exceeded or a condition has become immutable—that state information may be pruned to conserve resources and/or improve system performance.

After processing the user analytics data and/or applying the grouping rules, the system may store the results in the cloud-managed state store. This includes the updated groupings of users, any new insights derived from the data, and/or the pruned state information that reflects the latest state of user groupings.

In example embodiments, a top-level expression is a construct that represents the culmination of real-time computation processes applied to event-based aggregations. This expression synthesizes the results of one or more event-based aggregations (e.g., to form a comprehensive assessment of user activity or status), which can be used for user grouping, targeting, and/or other analytical outcomes, such as counting a number of events, counting averages, counting a number of times a person has purchases a product, or counting the total value of purchases.

The top-level expression may be computed through a series of steps that begin with the reception of a stream of event data. This data stream, which is associated with a plurality of users, may be processed to determine a set of event-based aggregations. These aggregations may be reflective of user interactions and/or behaviors (e.g., as dictated by a set of user-specified rules).

After the event-based aggregations are computed, the system may proceed to evaluate these aggregations against the user-specified rules to form the top-level expression. This evaluation may consider the logical relationships and dependencies defined within the rules, applying them to the aggregated data to derive a singular value or set of values that encapsulate the intended insights.

The top-level expression may serve as a decision-making tool within the system, enabling the dynamic grouping of users or the triggering of specific actions. For example, the expression may indicate whether a user qualifies for a particular group based on their recent activity, or it may trigger a marketing action if certain thresholds are met.

Upon computation, the top-level expression values for each user are stored (e.g., in the cloud-managed state store\). This storage not only preserves the computed values for immediate use but also ensures that they are available for ongoing analysis, historical comparisons, and/or future decision-making processes.

The advantages of utilizing a top-level expression within the system include the following:
Enhanced Analytical Precision: By integrating multiple event-based aggregations into a single expression, the system achieves a higher level of analytical precision, enabling more accurate user grouping and targeting;
Operational Efficiency: The computation of a top-level expression streamlines the decision-making process, as it reduces the need for multiple, separate evaluations of event-based aggregations; and/or
Scalability and Flexibility: The top-level expression concept allows the system to scale with the complexity of user-specified rules and the volume of event data, maintaining flexibility in how user data is analyzed and applied.

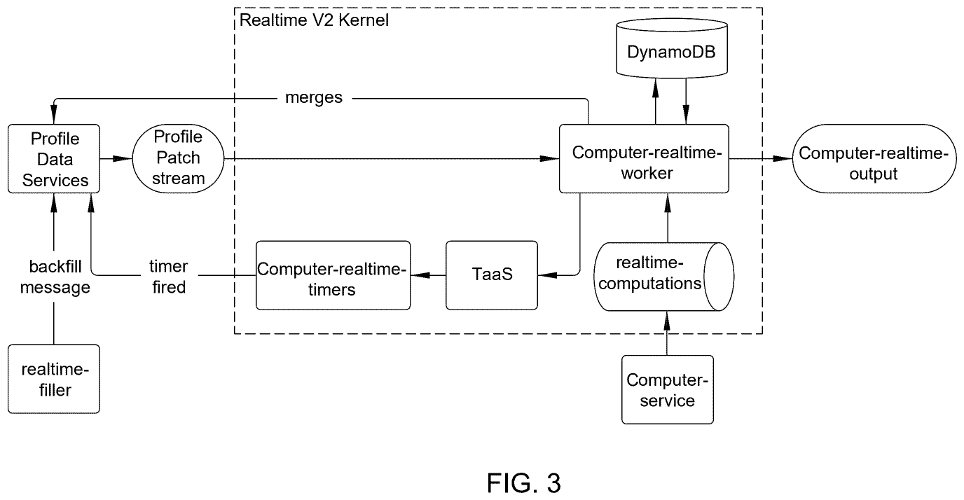

FIG. 3 is a block diagram depicting consumption from a profile patch stream.

The described system may consume from a Profile Patch Stream (PPS) in lieu of identified-messages, which provides several important advantages.

For example, an advantage is trait value materialization. The distributed-processing-engine-based implementation required the real-time compute kernel to perform its own “latest value wins” aggregations for all profile trait values referenced in computations. The state needed for these trait aggregations may have made up the majority of state stored in the clusters. Moving this trait value materialization to a profiles system allows the compute kernel to dramatically reduce the amount of state needed while allowing for a cleaner separation between the profiles and compute systems (e.g., because details about how to determine which value “wins” no longer need to leak downstream).

Another advantage is change notification. The patch stream may notify the compute kernel whenever a trait value changes, a profile is added or deleted (GDPR for free), or two profiles are merged.

The compute kernel of the described system may otherwise be compatible with aspects of the compute kernel of the distributed-processing-engine-based system. For example, it may accept the same real-time-filler backfill and resync messages and/or it may write to the compute-real-time-output in the same format, which means that the compute kernel implementation details may be transparent to a sync pipeline.

Separating state storage from the Stream Processing Module workers may include one or more of the following benefits:

Virtually unlimited elastic scaling—State storage like DynamoDB can elastically scale to accommodate arbitrary workload sizes. The system can thus scale Stream Processing Modules up and down to match event load without being constrained by state distribution bottlenecks.

Faster failure recovery—When a failed node recovers, it no longer needs to restore a local state snapshot before rejoining, which takes significant time in traditional architectures. The external state allows almost immediate recovery.

Reduced cold start times—New Stream Processing instances don't need to wait for state assignment and data loading-they can start processing events using the external state immediately.

Improved load balancing—With externalized state, the Control Plane can dynamically rebalance load across Stream Processors by routing traffic, rather than being locked into static state assignments.

Geographically distributed—State can be replicated across regions for geographic redundancy and local read performance. Stream Processors can be deployed closer to users.

Cost efficient scaling—Pay only for the state storage and Stream Processing capacity needed. Scale both up and down easily based on load, without over-provisioning.

More efficient backfills—Backfill updates can be distributed across many workers in parallel rather than being limited by static state shard locations.

By leveraging a fully managed, elastic, cloud-based state store, the architecture described herein decouples state from stream processing to deliver significantly higher performance, scalability, resilience, and efficiency. The system can handle spiky workloads and backfills that would overwhelm traditional real-time architectures

In example embodiments, one component of the described real-time compute kernel is a stream worker or compute-real-time-worker. This worker may be a Kafka Go-based worker that, for example, consumes profile patch stream changes and/or other updates (e.g., timer events or backfill events), outputs changes based on those updates and/or one or more computation rules stored in a real-time-computations database, and/or mutates per-user state in a database (e.g., DynamoDB).

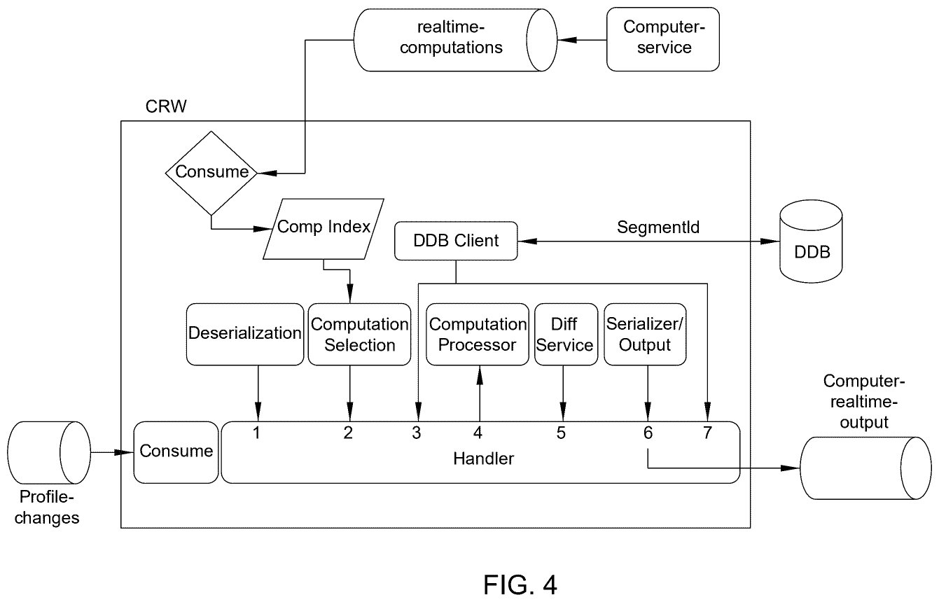

FIG. 4 is a block diagram depicting a detailed view of the worker's operation.

The worker may perform one or more of the following operations:
Consumes one or more patch stream (e.g., profile-changes) messages;
Deserializes the message;
Determines which (if any) computations should be re-computed due to the changes in this message (e.g., the currently-active list of computations may be stored in-memory (e.g., “Comp Index”), kept up-to-date by the Control plane: real-time-computations topic);
Reads the user's current compute-real-time database (e.g., DynamoDB) state;
Mutates the current compute-real-time state based on the updates in the message currently being processed;
Determines which top-level computation expression changes have occurred;
Outputs computation updates to the compute-real-time-output topic; and/or
Updates the database (e.g., DynamoDB) state to reflect the latest computed state.

The system may output and/or store consistent results even in the event of failure or contention. For example, it may not be adequate for the system to output an updated value without mutating the corresponding state, or vice-versa. Likewise, it may be bad for multiple processes or threads to mutate a user's state at the same time without concurrency boundaries.

In example embodiments, the system has one or more of the following properties:
All messages for a single segment_id are processed sequentially (e.g., from a single Kafka partition);
When processing a message, the system may perform one or more of the following operations:
Read state from the database (e.g., DynamoDB);
Compute a new updated state based on the input message;
Output to compute-real-time-output (if needed);
Write updated state to the database (e.g., DynamoDB) (if state has changed); For example, this state includes the Kafka offset of the message that caused the mutation; the write will be conditional, based on the existing state's Kafka offset being strictly lower than the written state's offset); and/or
Commit offsets (e.g., to Kafka).
Let's consider a few failure scenarios:
Failure/crash before output to compute-realtime-output: No output was made, no state was mutated, so no consistency issues. The system will retry the message from the beginning.

Failure/crash before writing updated state to the database: The system previously output an update. But the system didn't mutate state or commit offsets. This means that when the system retries the message, it will double-output the same exact update. This means that the system has “at least once” semantics, but the system is tolerant of a low level of duplicates. Perhaps more importantly, the system won't output competing or inconsistent values here.

Failure/crash before step committing offsets: The system previously output an update and also mutated our state. When the system retries this message, the system will see when reading the state from the database that we committed the message's offsets to the database when writing the updated state, so the system will just commit the message's offsets (e.g., to Kafka) without retrying it.

Concurrent steps before committing offsets: This scenario may occur if, for example, a consumer group was recently rebalanced, resulting in multiple consumers processing the same not-yet-committed messages. In this case, multiple workers will process the same output message (output to compute-realtime-output, at least once), but only one of them will succeed in mutating the database state due to the conditional update check.

If the system was just updating computations based on patch stream updates, it would be trivial for the system to ensure that all messages for a single segment_id will be processed sequentially from a single partition because the patch stream partitions its updates by segment_id. However, the system is also going to have updates coming from out-of-band that the system is going to need to process, such as, for example, one or more of the following:
Backfill messages;
Timer messages; and/or
“From-side” merge notifications.

The system's profiles system may be configured to provide a capability called “signaling events.” This capability allows profile-adjacent components to emit internal system events to the profile system that will be adorned with current profile state and emitted to the profile patch stream alongside segment-upstream profile events. This will allow compute-realtime-worker to consume all events in a strict order.

Computation state in the database (e.g., DynamoDB) may be keyed by segment_id. This means that all state across all computations for a particular user will be co-located in one key. This has an advantage of eliminating our workload amplification problem; one ingest message equals at most one state read and one state write, rather than the unbounded behavior that exists in a distributed-processing-engine-based system.

In order to make this approach cost-effective, the system may need to aggressively optimize the state size. The system may use one or more tricks here within the state schema, such as one or more of the following:
(1) Encode state (e.g., using Google Protocol Buffers) for efficient serialization;
(2) Refer to computations via small integers (e.g.,
short_computation_id). If the system were to store the full computation identifier (for example, aud_2H2zTtMAy1X01R4THYdtj0QOTVv) the system would need 32 bytes per ID, which adds up quickly for customers with many computations. Instead of using a full ID, if the system assigns each computation a unique small integer, the system only needs ˜2 bytes per ID (assuming fewer than 2\hat{ }16 computations per customer); and/or
(3) Aggressively prune unneeded state.

Let's take a look at an example protobuf state definition:

```
message UserRealtimeComputationState {
  /* Result section */
  // A list of all short_computation_ids that return true
  repeated uint64 bool_computation_id = 1;
  // A map of all evaluated node by their
  // computation short_id
  map<uint64, SingleComputationState> map_by_computation_id = 2;
}
message SingleComputationState {
  // Nodes whose values can continue to change
  map<uint64, EvaluatedNode> value_by_node_id = 1;
  // Node IDs whose value is “true” and can never change
  repeated uint64 true_terminal_node = 2;
  // Node IDs whose value is “false” and can never change
  repeated uint64 false_terminal_node = 3;
}
message EvaluatedNode {
  oneof aggregation_state {
    CountState count_state = 1;
    SumState sum_state = 2;
    MaxState max_state = 3;
    MinState min_state = 4;
    LastState last_state = 5;
    FirstState first_state = 6;
    // other aggregation state types can be added here
  }
}
<individual aggregation_state types omitted>
```

For each profile the system may store a single

UserRealtimeComputationState message, which may contain, for example,
(1) A list of computations which had previously evaluated to true. This allows the system to “diff” Boolean-based computations as the system sees updates to their constituent traits and event aggregations; and/or
(2) A map of per-computation event aggregation state (SingleComputationState)

How does this single computation state work? Essentially, the system takes the computation's expression tree and assigns each node in the tree a number (e.g., the node ID), and then stores the required event-aggregated state for that node keyed by that number. This per-node state can take one of two forms:
(1) Leaf node event aggregation. This is a standard aggregation (event count, max value, etc.); or
(2) Non-leaf terminal node. A “terminal node” is a non-leaf Boolean node that can never change from false to true or from true to false.

In example embodiments, rather than using large 32 byte IDs for computations, the system may assign small integer IDs (e.g. 1, 2, 3) to computations on a per-customer basis. This may allow the system to encode the computation IDs very efficiently in just a few bits/bytes rather than kilobytes. Parts of the expression tree can also be encoded using small integer IDs.

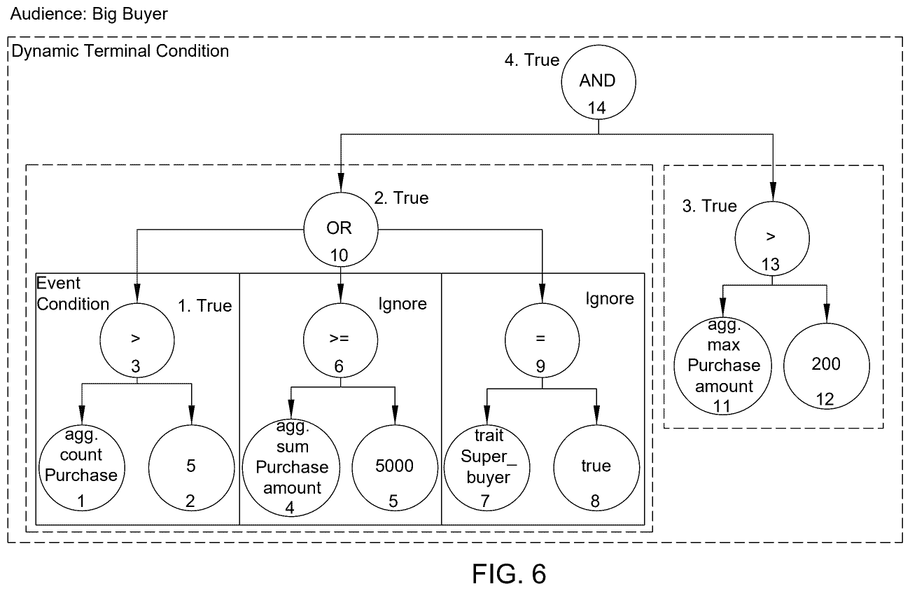

To understand this, let's consider an example computation expression, shown in FIG. 6.

As shown in FIG. 6, once they have completed five purchases, node 3 can never again evaluate to false, since there is no time window specified on the count aggregation. So while the system could continue counting purchases here, it would be a complete waste of time, space, and state write operations. In fact, node 10 will also always evaluate to true as well, meaning that if the system stores that “terminal” value for that node, the system will no longer have to aggregate nodes 4 and 7.

This optimized protobuf state may be wrapped in a database (e.g., DynamoDB) item. For example, here is a corresponding schema:

```
  type StoreItem struct {
  // PrimaryKey attribute that uniquely identifies this item in the store.
      PrimaryKey string ‘dynamodbav:″P″‘
  // StoreVersion attribute is used version the item State.
  //
  // Intended to provide a way forward to re-create item State for a
particular namespace, or,
  // globally, in the future.
  //
  // May also enable incremental iteration without having to drop tables.
  StoreVersion string ‘dynamodbav:″V″‘
  // State attribute contains the byte[ ] representation for arbitrary state
  values.
  //
  // For compute-realtime-worker, this contains serialized
user.UserRealtimeComputationState
  State [ ]byte ‘dynamodbav:″S″‘
    // Partition and offset of the last message to mutate state
    Partition int32 ‘dynamodbav:″T″‘
    Offset int64 ‘dynamodbav:″O″‘
    }
```

The system may have a primary key (e.g., the segment_id), a state version (e.g., allowing for future schema evolution), and/or the protobuf bytes themselves. For example, T (parTition) and O (Offset) Kafka-related entries may allow compute-realtime-worker to ensure consistency in the face of concurrency; all updates will be conditional that offset <=expected_kafka_offset. This means that no stale update could clobber a more recent one.

In order to support the state optimizations described above, the system may need to store control plane information specific to the compute kernel, such as in the following example:

```
type Computation struct {
  SpaceID string ‘json:″space_id″‘
  Id string ‘json:″id″‘
  ShortId uint64 ‘json:″short_id″‘
  Version uint64 ‘json:″version″‘
  Definition *ast.Node ‘json:″definition″‘
  Enabled bool ‘json:″enabled″‘
}
```

This information allows the system to track computation short IDs and versioning information, and it will allow the system to implement kernel-specific abstract syntax tree (AST) optimizations at computation creation time.

For example, the system may create a compacted Kafka topic (e.g., realtime-computations) keyed by id (e.g., computation ID). This means that the latest version of a Computation will always be available on the topic, and older versions may be garbage-collected.

When a computation is created by compute-service and assigned to the compute kernel, it will emit an update to this Kafka topic. The short_id can be assigned via a new column in the existing compute DB by adding one to the max existing short_id for the space_id in question.

The compute-realtime-worker may continuously consume from this Kafka topic, updating an in-memory store of all computation rules. The size of all extant real-time computation definitions is currently less than 100 MB (5 MB compressed!), so they can all be reasonably stored in-memory. When a new compute-realtime-worker instance starts up, it will consume this topic from the beginning in order to hydrate its in-memory computation store. This bootstrap action must complete before beginning to consume messages from the profile patch stream.

Many computations need to be re-evaluated after a certain amount of time passes. For example, consider the following computation pseudocode:
trait(signup_date) within_last 7_days

When a user signs up (and has their signup_date trait updated), the computation expression will evaluate to true. However, this expression will become false after 7 days have passed, even without any change to the customer's profile.

In order to re-evaluate such expressions after a period of time, the system may use a separate Timers as a Service (TaaS) system. This system may be designed to allow for the scheduling of a large number of timers with small (<96 byte) payloads. compute-realtime-worker will schedule a TaaS timer via its API whenever it detects that a computation will need to be re-evaluated due to a time-based condition.

The timer payload will contain the segment_id, space_id, and short computation ID:

{“sid”:“use_Yrb5I0coPB0hTHMn5Vh2K1SyAEm”,“sp”:“spa_ioEjwwoWH
U89SJHgjRRukC”,“comp”:342}

TaaS may be designed to call an RPC API when a timer fires. The system may implement a simple RPC service (e.g., compute-realtime-timers) to write these timer events back into the profile patch stream via its “signaling events” capability.

In example embodiments, the system can also run without timers by, for example, just waiting for data changes.

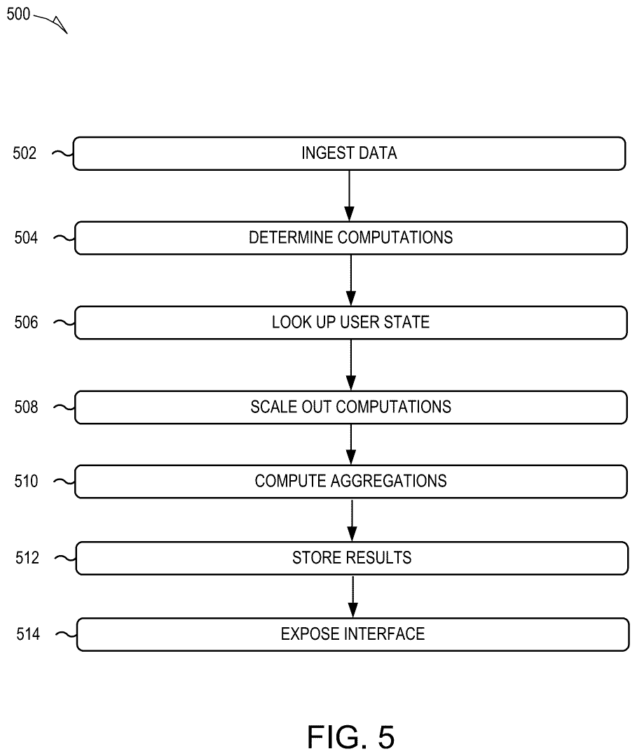

FIG. 5 is a flow chart of example operations for performing elastic real-time computations. The operations may be performed by one or more of the modules of FIG. 2. At operation 502, data is ingested. For example, incoming data streams is received and preprocessed before processing. This can include data validation, normalization, compression, etc.

At operation 504, computations are determined. For example, based on the incoming data streams, the system determines which event-based aggregations need to be computed for each user. This is based on defined real-time computations for the users.

At operations 506, user state is looked up. For example, the system looks up the current state information for each user from the separate cloud-managed state store.

At operation 508, computations are scaled out. For example, using the looked-up user state information, the system dynamically scales out computation by provisioning additional compute resources as needed.

At operation 510, aggregations are computed. For example, the determined event-based aggregations are computed for each user using the scaled-out computation resources. The computations are performed on the incoming data streams.

At operation 512, results are stored. For example, the computed aggregations are stored back in the cloud-managed state store, associated with each user.

At operations 514, an interface is exposed. For example, the interface allows retrieval of the computed aggregations for use in further processing or analytics.

One possible implementation of an elastic state store is AWS's DynamoDB.

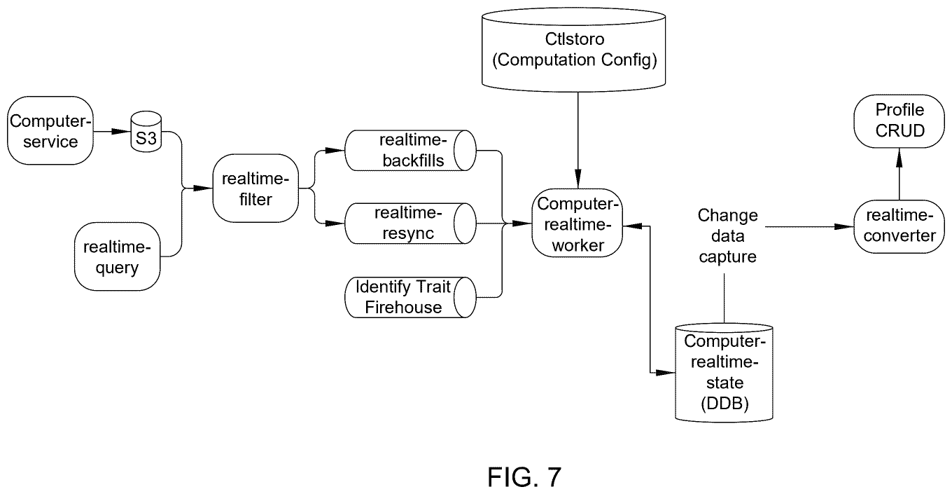

FIG. 7 is a block diagram illustrating an example elastic state store for DynamoDB.

This implementation may be based one or more of the following realizations:
Building on the profile patch stream means the compute system does not need to aggregate and store traits-all required trait data will be available on every inbound message. The only state required to be stored by the compute system is: Current calculated audience membership, Computed trait aggregations, and Event conditions used in audience calculations (e.g., can aggressively optimize what we store for each audience condition).

Co-locating all compute state data for a single user results in predictable, explainable costs—one ingest message equals one DynamoDB key lookup, and allows us to compute all computed trait and audience changes as a single unit.

The implementation may include a single worker implementation that knows how to consume from ITF and our backfill queue, possibly from separate pools. The basic flow may include one or more of the following operations (e.g., performed by one or more respective components of the system):
compute-realtime-worker: Read message from queue (backfill message or ITF message); Lookup computations for the associated space from ctlstore; Lookup the user's state from DDB; Mutate the state as necessary (see below); Write the state back to DDB using optimistic locking
realtime-converter: Detect the state change via DynamoDB CDC; Write the appropriate updates to the profile

What state would the system store? Consider the following two computations:

Audience 1:
operator(and)
+-operator(>=) // Event condition 1
| +-event.count(Order Completed)
| | +-operator(=)
| | | +-event.property.string(products.$.category)
| | | +-constant.string(Shoes)
| +-constant.integer(5)
+-operator(=)
| +-trait.string(region)
| +-constant.string(US)
Audience 2:
operator(and)
+-operator(>=) // Event condition 2
| +-event.count(Product Added)
| | { “duration” : “86400” }
| | +-operator(=)
| | | +-event.property.string(products.$.category)
| | | +-constant.string(Shoes)
| +-constant.integer(1)
+-operator(=)
| +-trait.string(region)
| +-constant.string(US)

The system has two audiences here, each of which has a single event condition and a trait reference. Here, an “event condition” may include an event aggregation plus a parent comparison operator that evaluates to a boolean value. Using “event conditions” rather than the underlying aggregations allows the system to perform some useful optimizations and store a very small amount of state, which will be useful in getting the most database (e.g., DynamoDB) bang for our buck.

In example embodiments, a goal may be to fit most customer computation definitions under a configurable size threshold (e.g., 1 kilobyte). This allows the system to co-locate the computation state for efficiency. It may also lower costs because smaller state means fewer resources needed. In example embodiments, the system may be configured to charge customers based on size of computations, incentivizing smaller state.

Here's an example of a single user's state, implemented as a single key/value pair in DynamoDB. Assume that our control plane is able to assign a low integer to each audience and each audience's event conditions (e.g., also helps us keep state size small). Also assume that the user's region trait value is US:

```
***{
  AudienceMembers: [ 2 ],
  EventConditions: {
    1: { Value: false, Count: 4 },
    2: { Value: true, ExpiresAt: ‘2023-03-01T12:00:00Z’ }
  },
  SeqNum: 7
}
```

This state contains the current audience membership list, plus the minimum amount of state needed to keep each event condition up-to-date.

Let's say that a new Order Completed event comes in that matches the filter criteria for event condition 1. A worker picks up the change, looks up the current state, and updates the value of the associated event condition and re-calculates the audience. The update from ITF will have the current value of the region trait, so between that and the new event condition value, we have everything we need to calculate the overall audience membership Boolean value:

```
{
  AudienceMembers: [ 1, 2 ],
  EventConditions: {
    1: { Value: true },
    2: { Value: true, ExpiresAt: ‘2023-03-01T12:00:00Z’ }
  },
  SeqNum: 8
}
```

Note that the system updated the audience membership set, the event condition value, and the overall sequence number (for optimistic concurrency control). Also note that the system can get rid of the “Count” field for the event condition—the aggregation is over all time, so the count will never decrease below 5, and subsequent Order Completed events don't need to bother updating or recomputing anything.

In example embodiments, once a user meets one or more criteria (e.g., purchased 5 times), that state is made permanent so that the system doesn't need to keep evaluating it. For example, the system may store a “True” value for that node, indicating it will always be true. This allows pruning (removing) downstream parts of the computation tree because they don't need to be evaluated anymore. For example, if purchases >−5 is true, the system can prune the subtree that was counting purchases.

Now let's imagine the system receives an update from ITF for this user setting the user's region trait to EU. The system's control plane will tell the system which computations the system needs to recalculate based on the trait change, and so the system writes out a new state:

```
{
  AudienceMembers: [ ],
  EventConditions: {
    1: { Value: true },
    2: { Value: true, ExpiresAt: ‘2023-03-01T12:00:00Z’ }
  },
  SeqNum: 9
}
```

realtime-converter sees the AudienceMembers change and is able to sync both audience changes in the same update!

Product wins may include one or more of the following:
Elastic capacity;
Say “yes” to large rate limit increase requests and new customer deals (assuming cost economics are good);
Absorb customer load spikes during special events, no need to switch to batch;
Improved e2e SLO;
Eliminates the long-tail deployment delays-zero-downtime deploys;
Ability to scale during periods of heavy load;
Faster first-time compute/higher concurrency limits;
Can scale in/out backfill workers and the state store to respond to computation creation and edit surges;
1 backfill message=1 unit of work;
Predictable explainable per-unit cost;
System cost scales linearly with the number of ingest messages/see (and scales in when load is low); and/or
1 message=1 re-computation per audience. Even if an identify call has multiple updates, we recompute affected audience one time.

Engineering wins may include one or more of the following:
Drastically reduced operations burden;
Zero-downtime deploys at any time instead of hours of after-hours babysitting;
“Instant” new capacity-let engineers build features instead of create new clusters;
AWS handles the state store ops;
Transactionality;
One message (backfill/identify call/event) is one unit of work;
Can finally answer the question “what message caused a user to enter an audience?”;
Developer velocity;
No need to worry about intricacies of Flink state or similar state (e.g., compatibility, max parallelism); and/or
Fewer moving parts.

The elastic real-time compute system's control plane construct may be a compiled real-time computation. This may be a real-time computation having an AST that has been split up into multiple constituent parts, each designed to compute a portion of the overall AST expression efficiently and with minimal state size. A compiled computation may include one or more of the following:
Compiled computation: the overall record of the compiled computation;
Event condition: an AST sub-expression involving an event aggregation. For example, count (Order Completed)>=1; Event condition entries can be shared by multiple compiled computations, if the expression is semantically the same for each;
Event condition reference: a mapping from event conditions to the compiled computations that reference them; and/or
Trait reference: a mapping from trait values to the compiled computations that reference them.

When a new computation is created by compute-service and assigned to the elastic real-time compute kernel, the computation may also be decomposed into a compiled computation and entries may be created in the personas-control DB for the constituent components of the compiled computation.

In example embodiments, the system incorporates a sophisticated pruning mechanism designed to optimize the management of state information within the system, as described herein. This mechanism supports the system's ability to process streams of data, including user analytics data, efficiently, and may be particularly advantageous for handling large volumes of data and complex user grouping rules.

State information may be data maintained by the system that reflects the current status of user analytics (e.g., as it relates to the user-specified rules for grouping). This information is dynamic and is continuously updated as new user analytics data is processed. The state information includes, but is not limited to, counts of event occurrences, timestamps of user actions, and evaluated conditions of user grouping rules.

The pruning mechanism may operate by analyzing the state information in conjunction with the user-specified rules to identify state data that no longer requires tracking or updating. This identification may be based on the logical structure of the rules and the current values within the state information. For example, if a rule specifies that a user should be grouped based on the occurrence of a particular event at least once, and the state information confirms that this event has occurred, further occurrences of this event may not impact the user's grouping status. In such cases, the mechanism can prune the tracking of this event for the user.

The criteria used by the pruning mechanism may be derived from the user-specified rules and/or the logical implications of the state information. The mechanism may evaluate whether s threshold has been met or exceeded in a manner that future data will not change the outcome of the rule evaluation, a condition has become permanently true or false, rendering further evaluation unnecessary, and/or redundant or duplicate state information exists that can be consolidated without loss of necessary detail.

The pruning mechanism may be implemented within the stream processing module of the system. It may use a combination of real-time data analysis and/or historical state evaluation to perform its function. The mechanism may be triggered as part of the regular processing cycle or upon specific events that indicate potential pruning opportunities, such as the receipt of data that satisfies a rule condition definitively.

The benefits of the pruning mechanism are multifold:
Resource Efficiency: By eliminating unnecessary state information, the system conserves storage and computational resources, leading to cost savings and improved performance;
Scalability: The pruning mechanism contributes to the system's scalability by ensuring that the growth of state information is managed proactively, allowing the system to handle increasing volumes of data without degradation in processing speed; and/or
Simplicity of State Management: Pruning simplifies the state management by reducing the complexity of the state information that must be maintained and evaluated during processing.

### Example Table Schemata

The constituent compiled computation components may be defined as tables (e.g., in the personas-control database). These tables may be replicated to ctlstore for low-latency access by individual workers.

In example embodiments, a design consideration of compiled computations and/or their constituent parts is that they should each have a short_id—that is, a small integer ID (unique on a per-space basis) which will allow the system to refer to them (e.g., in DynamoDB state) using very little storage. Using something like a large byte array, identifier (e.g., k-sortable unique identifier (KSUID) or immutable user identifier (e.g., a system UUID, GUID, or SID)) would require far more storage for each reference, so using small integers allows the system to cram a lot of information into a small amount of space.

compiled-realtime-computations

| column | ctlstore | primary | |
|---|---|---|---|
| name | data type | key? | notes |
| space_id | string | Y | |
| short_id | integer | Y | Increments per-space starting at 1 (to |
| | | | conserve state space) |
| long_id | string | | The standard audience or computed trait ID |
| expression | text | | Compiled computation AST JSON. Event |
| | | | condition definitions are replaced by an |
| | | | event_condition AST node type with the short |
| | | | condition ID as the value. |

realtime-event-conditions

| | ctlstore | primary | |
|---|---|---|---|
| column name | data type | key? | notes |
| space_id | string | Y | |
| short_id | integer | Y | Increments per-space starting at 1 (to |
| | | | conserve state space) |
| type | string | | Event condition type |
| event_name | string | | |
| filter_expression | text | | Can be NULL. If specified, a boolean |
| | | | AST expression used to match events |
| | | | that should be fed into this expression |
| definition | text | | Event condition dependent |

event-condition-references

| | ctlstore | primary | |
|---|---|---|---|
| column name | data type | key? | notes |
| space_id | string | Y | |
| computation_id | integer | Y | Short ID of computation referencing this |
| | | | condition |
| condition_id | integer | Y | |
| backfill_id | string | | ID of the field referring to this event |
| | | | condition. This allows us to re-use the |
| | | | existing backfill infrastructure with no |
| | | | changes |

trait-references

| | ctlstore data | primary | |
|---|---|---|---|
| column name | type | key? | notes |
| space_id | string | Y | |
| computation_id | integer | Y | Short ID of computation |
| | | | referencing this trait |
| trait_key | string | Y | |

### DynamoDB Schema

The state for each (space_id, segment_id) tuple may be stored as two keys in the database (e.g., DynamoDB):

```
  ***{
    V: <sequence_number>,
    P: <payload>
  }
  V will be a sequence number used for optimistic concurrency
control.
```

The main payload (P) will be a snappy-compressed protobuf structure:

```
message UserRealtimeComputationState {
  // A list of all short_audience_ids that this user is a member of
  //
  // Storage bytes per record: 2 bytes (assumes audience_id < 16384)
  // Overhead bytes: 1
  repeated uint64 audience_membership_id = 1 [packed=true];
  //
  // Individual event condition state type definitions go here
  //
  // The most recent N message IDs that mutated event condition
  // state and cannot be re-processed idempotently
  repeated string dedup_message_id = 1000;
  // The latest patch stream materialized profile version
  // reflected in this user's state.
  optional uint64 profile_state_version_watermark = 1001;
}
Event condition types
performed_all_time
```

This may be a condition type in audiences that checks to see if a particular event has been performed at least once over a user's entire history.

This condition type may only require a single Boolean of state for each condition, since once a particular event has been observed, the condition will evaluate to true forever:

// A list of the IDs of all performed_all_time conditions where the
// user has performed the event at least once.
//
// A performed_all_time condition is a non-windowed condition of the
// form:
// count(event) >= 1
// count(event) > 0
// count(event) == 0
// count(event) < 1
//
// Storage bytes per record: 2 bytes (assumes condition_id < 16384)
// Overhead bytes: 1
repeated uint64 performed_all_time_condition = 2 [packed=true];

Note that this works for both positive (performed at least once) and negative (never performed) conditions. In the event condition definition the system just needs to specify which to evaluate to true for the event condition expression:

{
“is_positive”: <true/false>
}
count_threshold

A more generalized version of performed_all_time may be an event condition type that checks to see if a user has performed an event more or less than N times.

```
// A CountThresholdCondition is a condition of the form:
// count(event) [comparison] N
// where N > 1
// and [comparison] is any integer comparison operator
// < <= = >= >
//
// We keep a separate backfill_count to ensure backfill
// idempotency but this can be combined with count once
// count + backfill_count >= N
//
// Storage bytes per record: 6
// * Assumes condition_id < 16384
// * Assumes N < 128
// * Assumes only one of count or backfill_count needed
// (on average)
// * Includes count_event_condition field ID byte
message CountThresholdCondition {
  required uint64 condition_id = 1;
  optional uint64 count = 2;
  optional uint64 backfill_count = 3;
}
repeated CountThresholdCondition count_threshold_condition = 3;
```

There are a few configuration options:

```
{
      “N”: <N>,
      “comparison” : <comparison>
}
window_count_threshold
  // A WindowCountThresholdCondition is any time-windowed event
  // condition of the form:
  // count(event) [comparison] N
  // where N > 1
  // and [comparison] is any integer comparison operator
  // < <= = >= >
  //
  message WindowCountThresholdCondition {
    required uint64 condition_id = 1;
    required uint64 last_window_time = 2;
    optional byte bitfield = 3;
  }
```

### Example Mobile Device

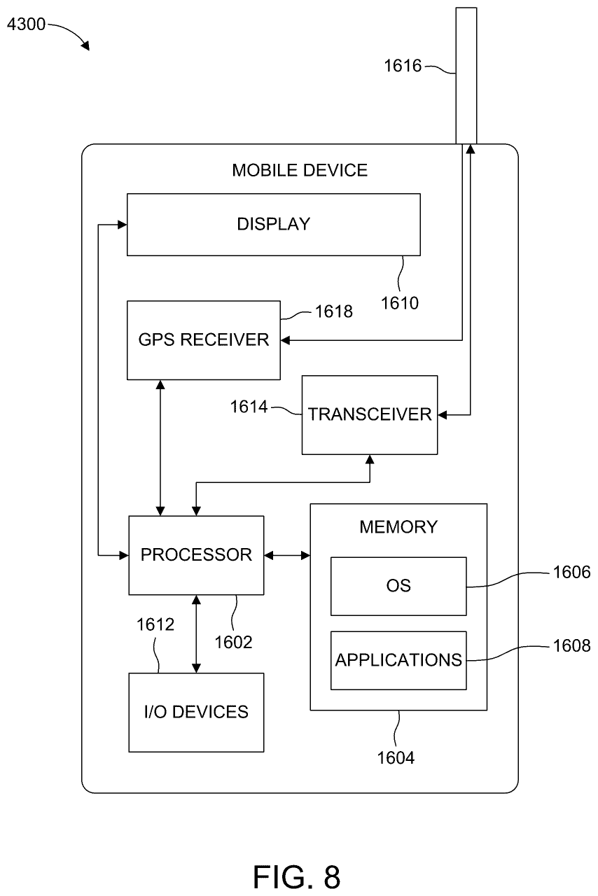

FIG. 8 is a block diagram illustrating a mobile device 4300, according to an example embodiment.

The mobile device 4300 can include a processor 1602. The processor 1602 can be any of a variety of different types of commercially available processors suitable for mobile devices 4300 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 4300. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

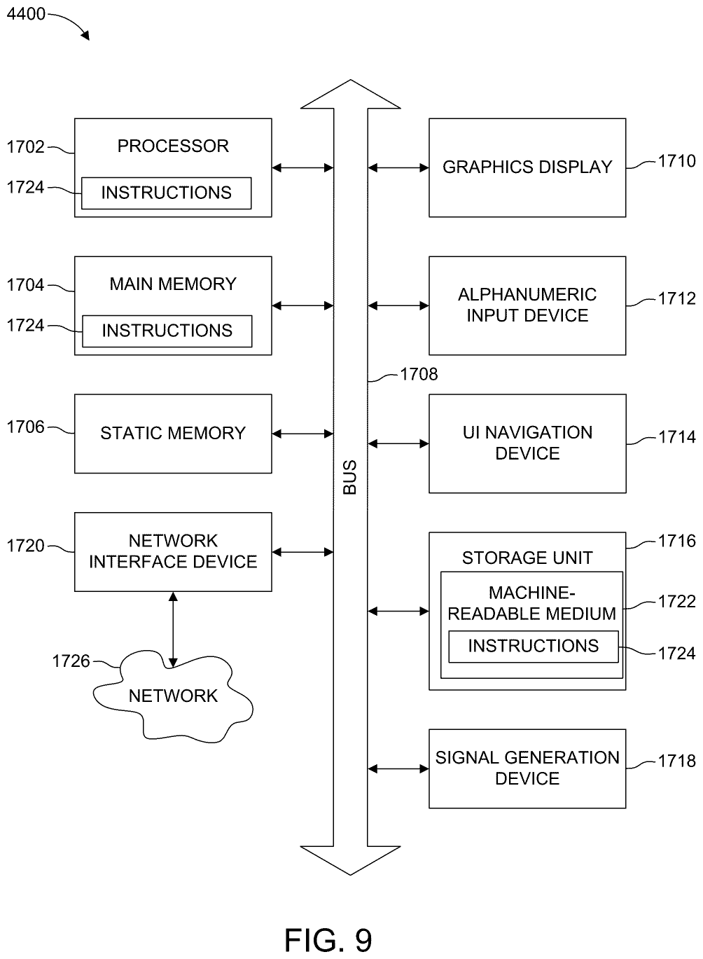

FIG. 9 is a block diagram of an example computer system 4400 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4400 includes a processor 1702 (e.g., a central processing unit (CPU), a graphics processing unit (GPU) or both), a main memory 1704 and a static memory 1706, which communicate with each other via a bus 1708. The computer system 4400 may further include a graphics display unit 1710 (e.g., a liquid crystal display (LCD) or a cathode ray tube (CRT)). The computer system 4400 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 4400, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instruction stored in the one or more computer memories, the set of instructions configuring the one or more computer processors to perform operations, the operations comprising:
loading a set of user specified rules for grouping users based on rules;
receiving a stream of user analytics data via a network;
storing state information for a real-time computation workload in a cloud-managed state store separate from a processing engine used to process the stream of data;
scaling out the real-time computation workload based on a volume of the user analytics data by utilizing the cloud-managed state store to retrieve state information;
processing the stream of data using the processing engine and utilizing the retrieved state information from the cloud-managed state store to group the user analytics data into groups based on the set of user specified rules; and
storing results of processing the stream of data in the cloud-managed state store.

2. The system of claim 1, wherein the cloud-managed state store comprises a database service providing high scalability and availability.

3. The system of claim 1, wherein scaling out the real-time computation workload comprises provisioning additional compute resources from a cloud provider to process the stream of data.

4. The system of claim 1, wherein the operations further comprise optimizing a size of the state information by representing identifiers in the state store using integer values.

5. The system of claim 4, wherein optimizing the size of the state information further comprises eliminating unnecessary fields from records in the state store.

6. The system of claim 1, wherein the distributed dataflow engine comprises a framework for stateful stream processing.

7. The system of claim 1, wherein the operations further comprise exposing an interface allowing retrieval of the results of processing the stream of data from the cloud-managed state store.

8. A method comprising:
loading a set of user specified rules for grouping users based on rules;
receiving a stream of user analytics data via a network;
storing state information for a real-time computation workload in a cloud-managed state store separate from a processing engine used to process the stream of data;
scaling out the real-time computation workload based on a volume of the user analytics data by utilizing the cloud-managed state store to retrieve state information;
processing the stream of data using the processing engine and utilizing the retrieved state information from the cloud-managed state store to group the user analytics data into groups based on the set of user specified rules; and
storing results of processing the stream of data in the cloud-managed state store.

9. The method of claim 8, wherein the cloud-managed state store comprises a database service providing high scalability and availability.

10. The method of claim 8, wherein scaling out the real-time computation workload comprises provisioning additional compute resources from a cloud provider to process the stream of data.

11. The method of claim 8, wherein the operations further comprise optimizing a size of the state information by representing identifiers in the state store using integer values.

12. The method of claim 11, wherein optimizing the size of the state information further comprises eliminating unnecessary fields from records in the state store.

13. The method of claim 8, wherein the distributed dataflow engine comprises a framework for stateful stream processing.

14. The method of claim 8, wherein the operations further comprise exposing an interface allowing retrieval of the results of processing the stream of data from the cloud-managed state store.

15. A non-transitory computer-readable storage medium storing a set of instructions that, when executed by one or more computer processors, causes the one or more computer processors to perform operations, the operations comprising:
loading a set of user specified rules for grouping users based on rules;
receiving a stream of user analytics data via a network;
storing state information for a real-time computation workload in a cloud-managed state store separate from a processing engine used to process the stream of data;
scaling out the real-time computation workload by utilizing the cloud-managed state store to retrieve state information;
processing the stream of data using the processing engine and utilizing the retrieved state information from the cloud-managed state store to group the user analytics data into groups based on the set of user specified rules; and
storing results of processing the stream of data in the cloud-managed state store.

16. The non-transitory computer-readable storage medium of claim 15, wherein the cloud-managed state store comprises a database service providing high scalability and availability.

17. The non-transitory computer-readable storage medium of claim 15, wherein scaling out the real-time computation workload comprises provisioning additional compute resources from a cloud provider to process the stream of data.

18. The non-transitory computer-readable storage medium of claim 15, wherein the operations further comprise optimizing a size of the state information by representing identifiers in the state store using integer values.

19. The non-transitory computer-readable storage medium of claim 18, wherein optimizing the size of the state information further comprises eliminating unnecessary fields from records in the state store.

20. The non-transitory computer-readable storage medium of claim 15, wherein the distributed dataflow engine comprises a framework for stateful stream processing.
